(19) United States
(12) Patent Application Publication
(10) Pub. No.: US 2022/0045875 A1
(43) Pub. Date: Feb. 10, 2022

(54) MULTICAST MESSAGE PROCESSING METHOD AND APPARATUS, STORAGE MEDIUM AND PROCESSOR

(71) Applicant: Suzhou Centec Communications Co., Ltd., Suzhou, Jiangsu (CN)

(72) Inventors: Jie ZHOU, Suzhou, Jiangsu (CN); Zhichuan HE, Suzhou, Jiangsu (CN); Haiqing XU, Suzhou, Jiangsu (CN); Wengang WANG, Suzhou, Jiangsu (CN); Zicang ZHAO, Suzhou, Jiangsu (CN)

(21) Appl. No.: 17/298,680

(22) PCT Filed: Nov. 19, 2019
(86) PCT No.: PCT/CN2019/119443

§ 371 Date: Jul. 29, 2021

(30) Foreign Application Priority Data
Dec. 4, 2018 (CN) 201811475768.9

(51) Int. Cl. H04L 12/18; H04L 12/733; H04L 12/743

(52) U.S. Cl. CPC H04L 12/18; H04L 45/7453; H04L 45/20

(57) ABSTRACT

Provided are a multicast message processing method and device, a storage medium and a processor. The method includes: a multicast group address is acquired from a received multicast message; according to the multicast group address, first routing information matching the multicast group address is searched in first data by means of a Hash algorithm; according to mark information and source address information of a multicast group, matched second routing information is searched in second data by means of the Hash algorithm; if the second routing information is found, the multicast message is sent according to next hop information of the multicast message in the second routing information; and if the second routing information is not found, the multicast message is sent according to the next hop information of the multicast message in the first routing information.

### CROSS-REFERENCE TO RELATED APPLICATION

The disclosure claims priority to Chinese Patent Application No. 201811475768.9, filed on Dec. 4, 2018 and entitled “Multicast message processing method and apparatus, storage medium and processor”, the disclosure of which is hereby incorporated by reference in its entirety.

### TECHNICAL FIELD

The disclosure relates to the field of network communications, and in particular to a multicast message processing method and device, a storage medium and a processor.

### BACKGROUND

There are following two situations during IP multicast searching.

The first is (s, g), that is, both a source IP address and a multicast group address are concerned during searching.

The second is (*, g), that is, only the multicast group address is concerned during searching.

The search result of (s, g) has a higher priority than that of (*, g).

A process of forwarding a message is briefly explained through the following example. As shown in FIG. 1, two multicast searching entries are configured on Route A, namely (*, 230.255.1.1) and (192.168.1.2, 230.255.1.1); when a message with the source IP address 192.168.1.1 and the multicast group address 230.255.1.1, it needs to be forwarded to Route B and Route C; and when the message with the source IP address 192.168.1.2 and the multicast group address 230.255.1.1, it is needed to be forwarded to Route D.

In the related art, the message is usually forwarded in the following two ways.

1) Two TCAM are used for searching. As shown in FIG. 2, when (*, g) and (s, g) exist in the same multicast group at the same time, two TCAM entries are needed to be occupied, and the cost of TCAM is high.

2) A Hash algorithm is used for searching. As shown in FIG. 3, when (*, g) and (s, g) exist in the same multicast group at the same time, two Hash entries are needed to be occupied, and (s, g) requires a complete entry to be configured, resulting in excessive consumption of table entries, especially when there are more than one (s, g) in the same multicast group, the additional consumption is more in IPv6.

In the related art, in the process of forwarding a message, using the TCAM for searching has a high cost, while when the Hash algorithm is used for searching, the table entries (*, g) and (s, g) are relatively independent, which causes the waste of table entries.

For the above problem, no effective solution has been proposed yet.

### SUMMARY

Embodiments of the disclosure provide a multicast message processing method and device, a storage medium and a processor to at least solve the technical problem of waste of table entries of a forwarding table due to the fact that a Hash algorithm is used for searching for the forwarding table and the table entries of the forwarding table are relatively independent in the related art.

According to an aspect of the embodiments of the disclosure, a multicast message processing method is provided, which may include the following steps: A multicast group address is acquired from a received multicast message; according to the multicast group address, first routing information matching the multicast group address is searched in first data by means of a Hash algorithm, and the first routing information includes multicast group mark information corresponding to the multicast group address and next hop information of the multicast message; according to mark information and source address information of a multicast group, matched second routing information is searched in second data by means of the Hash algorithm, and the second routing information includes the next hop information of the multicast message; If the second routing information is found, the multicast message is sent according to next hop information of the multicast message in the second routing information, and if the second routing information is not found, the multicast message is sent according to the next hop information of the multicast message in the first routing information.

In an embodiment, the first data includes: group address information, group mark information and next hop information. The group address information is a keyword of the Hash algorithm. The second data includes: group mark information, source address information and next hop information. The group address information and the resource address information is the keyword of the Hash algorithm.

In an embodiment, the operation that according to the multicast group address, the first routing information matching the multicast group address is searched in the first data may include that: according to the multicast group address, the multicast group mark information and the first routing information matching the multicast group address is searched in the first data by using the Hash algorithm.

In an embodiment, the operation that according to the multicast group mark information and the source address information, the matched second routing information is searched in the second data may include that: according to the multicast group mark information and the source address information, the matched second routing information is searched in the second data by using the Hash algorithm.

In an embodiment, after according to the multicast group address, the first routing information matching the multicast group address is searched in the first data, the method may include that: if the first routing information matching the multicast group address is not found in the first data according to the multicast group address, the multicast message is sent according to the next hop information of a default multicast message.

According to another aspect of the embodiments of the disclosure, a multicast message processing device is also provided, which may include: an acquiring unit, configured to acquire the multicast group address from the received multicast message; a first searching unit, configured to search for, according to the multicast group address, the first routing information matching the multicast group address in the first data by means of the Hash algorithm, the first routing information including: the multicast group mark information corresponding to the multicast group address and the next hop information of the multicast message; a second searching unit, configured to search for, according to the multicast group mark information and source address information, the matched second routing information in the second data by means of the Hash algorithm, the second routing information including: the next hop information of the multicast message; and a first sending unit, configured to send, if the second routing information is found, the multicast message according to the next hop information of the multicast message in the second routing information, and if the second routing information is not found, send the multicast message according to the next hop information of the multicast message in the first routing information.

In an embodiment, the first data includes: the group address information, the group mark information and the next hop information. The group address information is the keyword of the Hash algorithm. The second data includes the group mark information, the source address information and the next hop information. The group address information and the resource address information is the keyword of the Hash algorithm.

In an embodiment, the first searching unit is configured to search for, according to the multicast group address, the multicast group mark information and the first routing information matching the multicast group address in the first data by using the Hash algorithm.

In an embodiment, the second searching unit is configured to search for, according to the multicast group mark information and the source address information, the matched second routing information in the second data by using the Hash algorithm.

In an embodiment, the device further includes: a second sending unit, configured to send, if the first routing information matching the multicast group address is not found in the first data according to the multicast group address, the multicast message according to the next hop information of the default multicast message.

According to yet another aspect of the embodiments of the disclosure, a storage medium is also provided, which may include a stored program. When running, the program controls a device where the storage medium is to execute the multicast message processing method.

According to yet another aspect of the embodiments of the disclosure, a processor is also provided, which is configured to run a program. When running, the program executes the multicast message processing method.

In the embodiments of the disclosure, by means of compressing the multicast group address, when there are multiple (s, g) forwarding entries in one multicast group, the multicast group address is mapped by means of converging to a multicast group ID through a two-level Hash algorithm, and the multicast group address is acquired from the received multicast message; the first routing information matching the multicast group address is searched in the first data according to the multicast group address, the first routing information including: the multicast group mark information corresponding to the multicast group address and the next hop information of the multicast message; if the multicast message carries the source address information, the matched second routing information is searched in the second data according to the mark information and the source address information, the second routing information including: the next hop information of the multicast message; if the second routing information is found, the multicast message is sent according to the next hop information of the multicast message in the second routing information; and if the second routing information is not found, the multicast message is sent according to the next hop information of the multicast message in the first routing information. In this way, the purpose of saving table entries of a forwarding table is achieved, thereby achieving the technical effect of saving hardware resources and reducing costs, and then solving the technical problem of waste of the table entries of the forwarding table due to the fact that the Hash algorithm is used for searching for the forwarding table and the table entries of the forwarding table are relatively independent in the related art.

### BRIEF DESCRIPTION OF THE DRAWINGS

The accompanying drawings described here are used for providing further understanding of the disclosure, and constitute a part of the disclosure. Schematic embodiments of the disclosure and description thereof are used for illustrating the disclosure and not intended to form an improper limit to the disclosure. In the accompanying drawings:

FIG. 1 is a schematic diagram of an optional multicast message forwarding method;

FIG. 2 is a schematic diagram of searching for a message forwarding address using TCAM according to the traditional art;

FIG. 3 is a schematic diagram of searching for a message forwarding address using Hash according to the traditional art;

FIG. 4 is a flowchart of a multicast message processing method according to an embodiment of the disclosure;

FIG. 5 is a schematic diagram of an optional multicast message processing method according to an embodiment of the disclosure;

FIG. 6 is a flowchart of an optional multicast message processing method according to an embodiment of the disclosure; and

FIG. 7 is a structure diagram of a multicast message processing device according to an embodiment of the disclosure.

### DETAILED DESCRIPTION OF THE EMBODIMENTS

In order to make those skilled in the art understand the solutions of the disclosure better, the technical solutions in the embodiments of the disclosure are clearly and completely elaborated below in combination with the accompanying drawings. It is apparent that the described embodiments are only a part of the embodiments of the disclosure but not all. Based on the embodiments of the disclosure, all the other embodiments obtained by those of ordinary skill in the art on the premise of not contributing creative effort should belong to the protection scope of the disclosure.

It is to be noted that the terms like “first” and “second” in the specification, claims and accompanying drawings of the disclosure are used for differentiating the similar objects, but do not have to describe a specific order or a sequence. It should be understood that the objects may be exchanged under appropriate circumstances, so that the embodiments of the disclosure described here may be implemented in an order different from that described or shown here. In addition, terms “include” and “have” and any variations thereof are intended to cover non-exclusive inclusions. For example, it is not limited for processes, methods, systems, products or devices containing a series of steps or units to clearly list those steps or units, and other steps or units which are not clearly listed or are inherent to these processes, methods, products or devices may be included instead.

In the related art, in the process of forwarding a message, using TCAM to search for a forwarding table according to a message has a high cost, while when a Hash algorithm is used for searching, the table entries (*, g) and (s, g) are relatively independent, which causes the waste of table entries.

To solve the above problem, the embodiments of the disclosure provide a corresponding solution. In the disclosure, first-level convergent mapping is performed on a multicast group address, the search result of the first-level (*, g) in the same multicast group is taken as the input of the second-level (s, g), so that the two are associated, thereby saving table entries of (s, g), as explained in detail below.

According to the embodiments of the disclosure, an embodiment of a multicast message processing method is provided. It is to be noted that these steps presented in the flowchart of the accompanying drawings can be executed in a computer system like a group of computer executable instructions, and moreover, although a logical sequence is shown in the flowchart, in some cases, the presented or described steps can be performed in a sequence different from that described here.

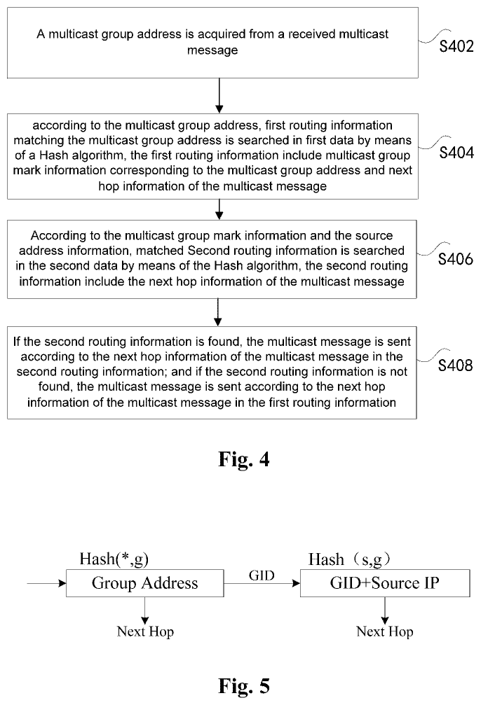

FIG. 4 is a flowchart of a multicast message processing method according to an embodiment of the disclosure. As shown in FIG. 4, the method includes the following steps.

At S402, a multicast group address is acquired from a received multicast message.

In the embodiment of the disclosure, the multicast message may be a data packet, and carries source address information.

At S404, according to the multicast group address, first routing information matching the multicast group address is searched in first data by means of a Hash algorithm, the first routing information including: multicast group mark information corresponding to the multicast group address and next hop information of the multicast message.

In the embodiment of the disclosure, the first data includes: group address information, group mark information and next hop information. The group address information is a keyword of the Hash algorithm. The first data may be the first-level Hash (*, g), where g represents a group address. The multicast group mark information may be represented by ID(GID), and a group ID may be (g_id). The group ID may be obtained through the multicast group address, and there is a corresponding relationship between the group ID and the group address. The next hop information includes next address information and next hop exit information. The next hop exit information may be multiple exit information.

At S406, according to the multicast group mark information and the source address information, matched second routing information is searched in the second data by means of the Hash algorithm, the second routing information including: the next hop information of the multicast message.

In the embodiment of the disclosure, the second data includes: group mark information, source address information and next hop information. The group address information and the resource address information is the keyword of the Hash algorithm. The second data may be the second-level Hash (s, g), where s represents a source address and g represents a group address.

At S408, if the second routing information is found, the multicast message is sent according to the next hop information of the multicast message in the second routing information; and if the second routing information is not found, the multicast message is sent according to the next hop information of the multicast message in the first routing information.

In the embodiment of the disclosure, after according to the multicast group address, the first routing information matching the multicast group address is searched in the first data, if the first routing information matching the multicast group address is not found in the first data according to the multicast group address, the multicast message is sent according to the next hop information of a default multicast message.

Through the above steps, the message may be forwarded to a corresponding exit according to next hop address information. The message to be forwarded may be directly forwarded to the exit, or the message to be forwarded is copied first, and then the copied message is sent to the exit.

In the embodiment of the disclosure, that according to the multicast group address, the first routing information matching the multicast group address is searched in the first data includes that: according to the multicast group address, the multicast group mark information and the first routing information matching the multicast group address is searched in the first data by using the Hash algorithm. That according to the multicast group mark information and the source address information, the matched second routing information is searched in the second data includes that: according to the multicast group mark information and the source address information, the matched second routing information is searched in the second data by using the Hash algorithm. The Hash algorithm is used for searching in each level of data structure. A two-level serial Hash algorithm is used in the embodiment of the disclosure, the output of the first level is used as the input of the second level, and the purpose of saving table entries is achieved by means of performing convergent mapping on the multicast group.

In an optional embodiment, as shown in FIG. 5, the data structures in the disclosure include a first data structure and a second data structure.

The data structure of the first data, namely the data structure in the first-level Hash (*, g) with a size of 8 bytes, is defined as follows (taking IPv4 as an example):

uint32 g_addr; //group address
uint16 nh_id; //next hop information
uint16 g_id; //group id

where g_addr is used as the key of the Hash algorithm, nh_id and g_id are used as the Hash search result, nh_id is the next hop information (that is, the next hop exit information), and g_id is used as part of the key of the second-level Hash algorithm. g_id represents a certain multicast group. Because the number of multicast groups on each device is limited in actual use, usually only a few thousand at most, it is enough to define it as uint16, that is, g_addr is mapped to g_id by means of converging.

The data structure of the second data, namely the data structure in the second-level Hash (s, g) with a size of 8 bytes, is defined as follows (taking IPv4 as an example):

uint32 s_addr; //source ip address
uint16 g_id; //group_id
uint16 nh_id; //next hop information

where s_addr and g_id are jointly used as the key of the Hash algorithm, nh_id is used as the Hash search result, and nh_id is the next hop information. g_id represents a certain multicast group that represents the search result of the first-level Hash algorithm.

For IPv6, the width of g_addr and s_addr needs to be defined to 128 bits, and the rest is consistent with IPv4.

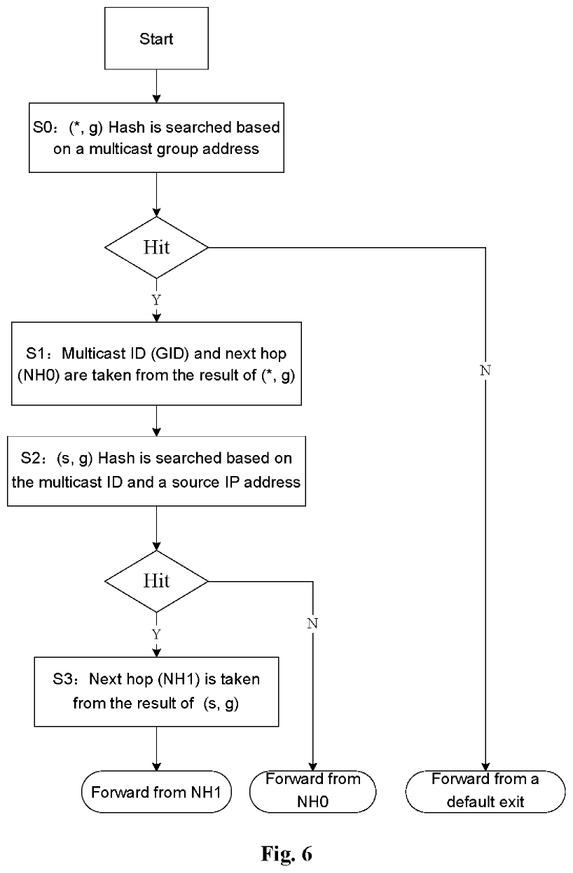

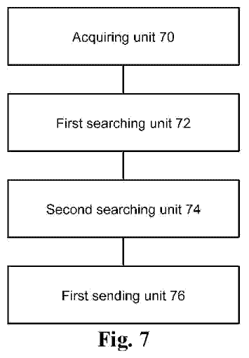

The disclosure provides an optional implementation mode. As shown in FIG. 6, based on the data structure of the above two-level Hash algorithm, a search process is as follows.

At S0, the multicast group address in the message is used for searching in the first-level Hash(*, g). If the message is searched, enter S1; or else, the message is forwarded to a default exit.

At S1, a multicast group ID (g_id) and the next hop information NH0 are taken from the search result of Hash(*, g), and enter S2.

At S2, a source IP address in the message and the multicast group ID (g_id) are used for searching. If the message is searched, enter S3; or else, the message is forwarded to the exit represented by the NH0.

At S3, the next hop information NH1 is taken from the search result of Hash(s, g), and the message is forwarded to the exit represented by the NH1.

Through the above steps, when there are multiple (s, g) forwarding entries in one multicast group, hardware resources may be greatly saved. For example, if there are 10 (s, g) entries and 1 (*, g) entry in a certain IPv4 multicast group, then the total amount of hardware resources occupied is 810+8=88 bytes (1010+6=106 bytes required by the traditional Hash algorithm). Similarly, if there are 10 (s, g) entries and 1 (*, g) entry, in a certain IPv6 multicast group, then the total amount of hardware resources occupied is 20*10+20=210 bytes (34*10+18=358 bytes required by the traditional Hash algorithm).

According to the embodiments of the disclosure, an embodiment of a multicast message processing device is provided. FIG. 7 is a structure diagram of a multicast message processing device according to an embodiment of the disclosure. As shown in FIG. 7, the device includes: an acquiring unit 70, a first searching unit 72, a second searching unit 74 and a first sending unit 76.

The acquiring unit 70 is configured to acquire the multicast group address from the received multicast message.

The first searching unit 72 is configured to search for, according to the multicast group address, the first routing information matching the multicast group address in the first data by means of the Hash algorithm. The first routing information includes: the multicast group mark information corresponding to the multicast group address and the next hop information of the multicast message.

The second searching unit 74 is configured to search for, according to the multicast group mark information and the source address information, the matched second routing information in the second data by means of the Hash algorithm. The second routing information includes: the next hop information of the multicast message.

The first sending unit 76 is configured to send, if the second routing information is found, the multicast message according to the next hop information of the multicast message in the second routing information, and if the second routing information is not found, send the multicast message according to the next hop information of the multicast message in the first routing information.

In an embodiment, the first data includes: the group address information, the group mark information and the next hop information. The group address information is the keyword of the Hash algorithm. The second data includes: the group mark information, the source address information and the next hop information. The group address information and the resource address information is the keyword of the Hash algorithm.

In an embodiment, the first searching unit 72 is configured to search for, according to the multicast group address, the multicast group mark information and the first routing information matching the multicast group address in the first data by using the Hash algorithm.

In an embodiment, the second searching unit 74 is configured to search for, according to the multicast group mark information and the source address information, the matched second routing information in the second data by using the Hash algorithm.

In an embodiment, the device further includes: a second sending unit, configured to send, if the first routing information matching the multicast group address is not found in the first data according to the multicast group address, the multicast message according to the next hop information of the default multicast message.

Through the above device, the first-level convergent mapping is performed on the multicast group address, the search result of the first-level (*, g) in the same multicast group is taken as the input of the second-level (s, g), so that the table entries are associated, thereby saving the table entries of (s, g).

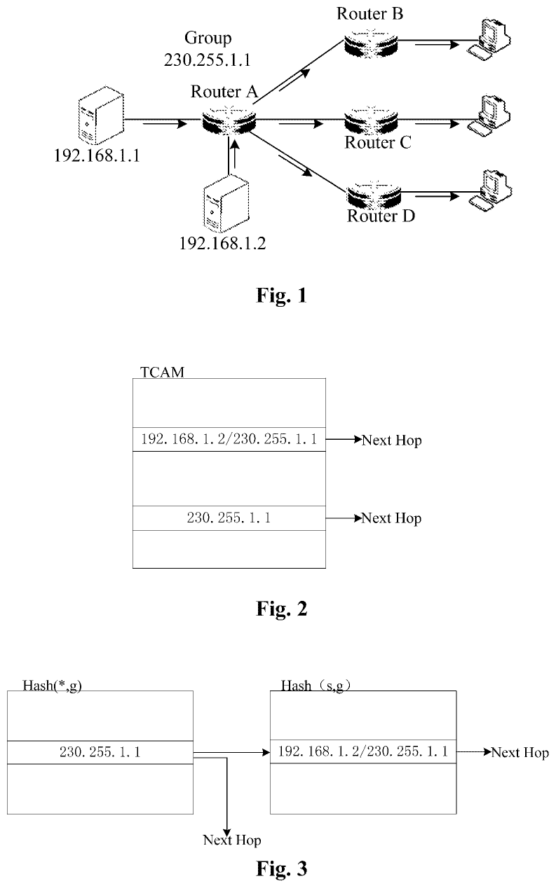

It is to be noted that the related description of FIG. 1 to FIG. 6 may act as a reference for the preferred implementation mode of the embodiment shown in FIG. 7, so the preferred implementation mode will not be repeated here.

The embodiments of the disclosure also provide a storage medium, which includes a stored program. When running, the program controls a device where the storage medium is to execute the above multicast message processing method.

The embodiments of the disclosure also provide a processor, which is configured to run a program. When running, the program executes the multicast message processing method.

The sequence numbers of the embodiments of the disclosure are just for describing, instead of representing superiority-inferiority of the embodiments.

In the above embodiments of the disclosure, the descriptions of the embodiments focus on different aspects. A part which is not described in a certain embodiment in detail may refer to the related description of the other embodiments.

In the several embodiments provided in the disclosure, it should be understood that the technical contents disclosed may be realized in other ways. The embodiment of the device described above is only schematic; for example, the division of the units is only a division of logical functions, and there may be other dividing modes during the actual implementation, for example, multiple units or components may be combined or integrated to another system, or some features may be ignored or are not executed. In addition, coupling, direct coupling, or communication connection shown or discussed may be implemented through indirect coupling or communication connection of some interfaces, units or modules, and may be in an electrical form or other forms.

The units described as separate parts may be or may not be separate physically. The part shown as the unit may be or may not be a physical unit, that is to say, it may be in a place or distributed on multiple network units. Part or all of the units may be selected to achieve the purpose of the solutions of the embodiments according to a practical requirement.

Moreover, all the function units in the embodiments of the disclosure may be integrated in a processing unit; or the units exist separately and physically; or two or more than two units are integrated in a unit. The integrated unit may be realized in form of hardware or in form of software function unit.

If the integrated unit is implemented by software function modules, and the software function modules are sold or used as independent products, they can also be stored in a computer readable storage medium. Based on this understanding, the technical solution of the embodiments of the disclosure substantially or the part making a contribution to the conventional art can be embodied in the form of software product; the computer software product is stored in a storage medium, and includes a number of instructions to make a computer device (which may be a personal computer, a server or a network device, etc.) perform all or part of steps of the method in each embodiment of the disclosure. The storage media include, but not limited to, a USB flash disk, a Read-Only Memory (ROM), a Random Access Memory (RAM), a mobile hard disk, a magnetic disk, a compact disc, and other media capable of storing the program codes.

The above is only the preferred embodiments of the disclosure; it should be indicated that, on the premise of not departing from the principles of the disclosure, those of ordinary skill in the art may also make a number of improvements and supplements, and these improvements and supplements should fall within the protection scope of the disclosure.

1. A multicast message processing method, comprising:
acquiring a multicast group address from a received multicast message;
searching for, according to the multicast group address, first routing information matching the multicast group address in first data by means of a Hash algorithm, wherein the first routing information comprises multicast group mark information corresponding to the multicast group address and next hop information of the multicast message;
searching for, according to the multicast group mark information and source address information, matched second routing information in second data by means of the Hash algorithm, wherein the second routing information comprises the next hop information of the multicast message;
if the second routing information is found, sending the multicast message according to the next hop information of the multicast message in the second routing information; and if the second routing information is not found, sending the multicast message according to the next hop information of the multicast message in the first routing information.

2. The method according to claim 1, wherein,
the first data comprises: group address information, group mark information and next hop information, wherein the group address information is a keyword of the Hash algorithm;
the second data comprises: group mark information, source address information and next hop information, wherein the group address information and the resource address information is the keyword of the Hash algorithm.

3. The method according to claim 1, wherein searching for, according to the multicast group address, the first routing information matching the multicast group address in the first data comprises: searching for, according to the multicast group address, the multicast group mark information and the first routing information matching the multicast group address in the first data by using the Hash algorithm.

4. The method according to claim 1, wherein searching for, according to the multicast group mark information and the source address information, the matched second routing information in the second data comprises: searching for, according to the multicast group mark information and the source address information, the matched second routing information in the second data by using the Hash algorithm.

5. The method according to claim 1, wherein after according to the multicast group address, searching for the first routing information matching the multicast group address in the first data, the method comprises: if the first routing information matching the multicast group address is not found in the first data according to the multicast group address, sending the multicast message according to the next hop information of a default multicast message.

6. A multicast message processing device, comprising:
an acquiring unit, configured to acquire a multicast group address from a received multicast message;
a first searching unit, configured to search for, according to the multicast group address, first routing information matching the multicast group address in first data by means of a Hash algorithm, wherein the first routing information comprises multicast group mark information corresponding to the multicast group address and next hop information of the multicast message;
a second searching unit, configured to search for, according to the multicast group mark information and source address information, matched second routing information in second data by means of the Hash algorithm, wherein the second routing information comprises: the next hop information of the multicast message; and
a first sending unit, configured to send, if the second routing information is found, the multicast message according to the next hop information of the multicast message in the second routing information, and if the second routing information is not found, send the multicast message according to the next hop information of the multicast message in the first routing information.

7. The device according to claim 6, wherein,
the first data comprises: group address information, group mark information and next hop information, wherein the group address information is a keyword of the Hash algorithm;
the second data comprises: group mark information, source address information and next hop information, wherein the group address information and the resource address information is the keyword of the Hash algorithm.

8. The device according to claim 6, wherein the first searching unit is configured to search for, according to the multicast group address, the multicast group mark information and the first routing information matching the multicast group address in the first data by using the Hash algorithm.

9. The device according to claim 6, wherein the second searching unit is configured to search for, according to the multicast group mark information and the source address information, the matched second routing information in the second data by using the Hash algorithm.

10. The device according to claim 6, further comprising:
a second sending unit, configured to send, if the first routing information matching the multicast group address is not found in the first data according to the multicast group address, the multicast message according to the next hop information of a default multicast message.

11. A non-transitory storage medium, comprising a stored program, wherein when running, the program controls a device in which the storage medium is to execute a multicast message processing method as claimed in claim 1.

12. A processor, configured to run a program, wherein when running, the program executes a multicast message processing method as claimed in claim 1.

13. A non-transitory storage medium, comprising a stored program, wherein when running, the program controls a device in which the storage medium is to execute a multicast message processing method as claimed in claim 2.

14. A non-transitory storage medium, comprising a stored program, wherein when running, the program controls a device in which the storage medium is to execute a multicast message processing method as claimed in claim 3.

15. A non-transitory storage medium, comprising a stored program, wherein when running, the program controls a device in which the storage medium is to execute a multicast message processing method as claimed in claim 4.

16. A non-transitory storage medium, comprising a stored program, wherein when running, the program controls a device in which the storage medium is to execute a multicast message processing method as claimed in claim 5.

17. A processor, configured to run a program, wherein when running, the program executes a multicast message processing method as claimed in claim 2.

18. A processor, configured to run a program, wherein when running, the program executes a multicast message processing method as claimed in claim 3.

19. A processor, configured to run a program, wherein when running, the program executes a multicast message processing method as claimed in claim 4.

20. A processor, configured to run a program, wherein when running, the program executes a multicast message processing method as claimed in claim 5.
